(19) United States
(12) Patent Application Publication
(10) Pub. No.: US 2009/0072612 A1
(43) Pub. Date: Mar. 19, 2009

(54) Spoke wheel protector

(76) Inventor: Steven Mason, Ontario, CA (US)

Correspondence Address: Lewis M. Brande, 5976 Falling Tree Lane, Alta Loma, CA, 91737-2816, US

(21) Appl. No.: 11/901,168

(22) Filed: Sep. 14, 2007

(51) Int. Cl. B60B 7/06; B60B 7/00

(52) U.S. Cl. 301/37.41

(57) ABSTRACT

A Spoke Seal Protector that comprises a visually pleasing outer shape with an internal cavity, where the internal cavity has a lower portion shaped complimentary to the industry standard wheel adjusters on the wheel spokes of either motorcycles, bicycles, or other motor conveyances using spoked wheels. The Spoke Seal Protector is adhered onto the spoke adjustor and the internal cavity encases the spoke adjuster. A common automotive or industry sealant is placed in the lower counterbored portion of the Spoke Seal Protector and “glues” the Spoke Seal Protector to the spoke adjuster nut and creates an environmental seal between the components.

### BACKGROUND OF THE INVENTION

1. Field of the Invention

This invention is an improvement of U.S. Pat. No. 6,588,852 by Steven Mason dated Jul. 8, 2003, and U.S. Pat. No. 7,140,694 B2 dated Nov. 28, 2006. This new invention relates to a device that protects the spoke adjuster nuts and the wheel rim areas of spoked wheels from the intrusion of foreign objects such as dirt. By adding this device to spoked wheels, they will enhance the functionality of the spoke adjusting areas of the wheel rims by increasing the life span of the spoked wheels and also provide a decorative addition to the spoked wheel.

2. Description of the Prior Art

The use of devices to protect the adjustment areas of wheel spokes is known in the prior art.

U.S. Pat. No. 6,588,852 by Steven Mason (the inventor of the current invention) reveals a wheel spoke adjuster guard that comprises a pleasing outer appearance with an internal cavity complementary to the wheel adjuster nuts on the wheel spokes of a wheel. The adjuster guard has means to lock the guard onto a wheel spoke, preventing unwanted motion.

U.S. Pat. No. 7,140,694 B2 by Steven Mason (the inventor of the current invention) reveals an improvement on the U.S. Pat. No. 6,588,852. This patent reveals a wheel spoke adjuster guard that comprises a pleasing outer appearance with an internal cavity complementary to the wheel adjuster nuts on the wheel spokes of a wheel. The improved adjuster guard is threaded onto a modified spoke adjuster and bears against the tire rim of the vehicle, locking the wheel spoke adjuster guard into place, preventing unwanted motion.

U.S. Pat. No. 4,906,050 by Soder et al., discloses “Beads for Bicycle Wheel Spokes.” The principle purpose of this invention is to provide visual and audible effects while the wheel is being used. This invention discloses a bead that is free to move along the length of the spoke, which then creates a pleasing visual effect. This invention is specifically related to the creation of a visual effect and an audible noise.

U.S. Pat. No. 4,695,099 by Klein, discloses a “Wheel Spoke Adjuster Guard.” This invention is a two-piece device that is snapped together around the adjuster lug portion of the spoked wheel.

U.S. Pat. No. 2,558,423 by Dobrosky, discloses “A Spoke Ornament for Bicycle Wheels.” This device uses tubular sections in unison, where when connected together, have interlocking key areas that prevent any one element from being dislodged from the spoke. This invention is ornamental in concept. When attached to a bicycle wheel, the alternating colors create alternating bands of color while the wheel is moving.

U.S. Pat. No. 2,269,670 by Kieckbusch, discloses a “Balance Weight.” This invention is used to balance motorcycle wheels inexpensively, easily and simply.

U.S. Pat. No. 5,801,883 by Peters, discloses “High Visibility Reflective Tubing for Bicycle Wheels.” This invention is to create a highly reflective area of a bicycle rim in order to enhance the bicyclist's visibility in low light and bad weather conditions.

U.S. Pat. Nos. 4,906,050, 2,558,423, and 5,801,883 contain no teaching or suggestion that they may be used to attach to the lug area of spoked wheels and prevent the intrusion of foreign materials. They specifically teach the art of either enhancing the visibility of the operator, or making a pleasing sound.

### SUMMARY OF THE INVENTION

It is an object of the invention to create a one piece device that can protect the adjusting lug areas, the threaded end of the spoke, and the wheel rim holes of spoked wheel assemblies from the intrusion of foreign materials such as dirt.

The new improvement uses a slideable cover or cowl that uses a environmental sealant to glue the spoke seal protector proximate to the spoke adjuster nut and the tire rim. The environmental sealant also prevents dirt and other abrasive material, as well as liquids from migrating into the tire rim, and acting as an abrasive at the interface between the tire rim and spoke adjuster nut.

It is another object of the invention to create an aesthetically pleasing appearance to the spokes and the wheel.

Other objects, advantages, and novel features of the present invention will become apparent from the following detailed description of the invention when considered in conjunction with the drawings accompanying the patent.

### BRIEF DESCRIPTION OF THE DRAWINGS

FIG. 1 shows a view of an overall view of a wire rim with the Spoke Seal Protector installed

FIG. 2 shows a cross section of the rim, spoke and Spoke Seal Protector

FIG. 3 shows a second embodiment of the rim, spoke and Spoke Seal Protector

FIG. 4 shows a cross section of the second embodiment of the rim, spoke and Spoke Seal Protector.

FIG. 5 shows a third embodiment of the rim, spoke and Spoke Seal Protector

FIG. 6 shows a cross section of the third embodiment of the rim, spoke and Spoke Seal Protector.

FIG. 7 shows a third embodiment of the rim, spoke and Spoke Seal Protector having a bevel cut to provide a coarse seal between the Spoke Seal Protector and the rim

FIG. 8 shows a cross section of the third embodiment of the rim, spoke and Spoke Seal Protector.

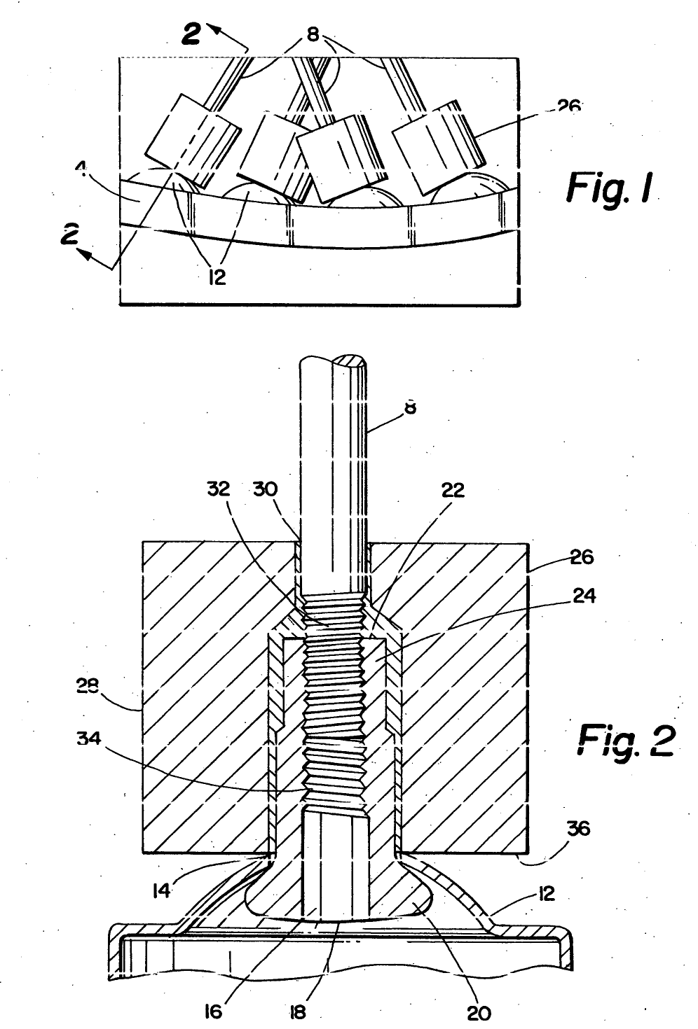

### DETAILED DESCRIPTION

Although the foregoing includes a description of the best mode contemplated for carrying out the invention, various modifications are contemplated.

As various modifications could be made in the constructions herein described and illustrated without departing from the scope of the invention, it is intended that all matter contained in the foregoing description or shown in the accompanying drawings shall be interpreted as illustrative rather than limiting.

With respect to figures one and two a wire wheel assembly (1) is shown. The wire wheel assembly (1) contains a central disk (2) and an outer tire mounting rim (4) or wheel rim. The central disk (2) has a first plurality of holes (6) defined therethrough. Wire spokes (8) are inserted through the first plurality of holes (6) and extend radially from the central disk (2). The wheel rim (4) has a cross sectional shape that is common in the wheel industry. The wheel rim (4) has an inner surface (10), where the inner surface (10) is facing towards the central disk (2) and oriented at a 90 degree angle to the central disk (2); i.e. the central disk (2) being circular in shape, defines a plane that is normal to the inner surface (10) of the wheel rim (4). Integrally mounted onto the inner surface (10) of the wheel rim (4) is a first plurality of bearing surfaces (12) which may be spherical in shape, where the quantity of the first plurality of bearing surfaces (12) equals quantity of the first plurality of holes (6). The first plurality of bearing surfaces (12) and hence the inner surface (10) of the wheel rim (4) have a second plurality of holes (14) defined therethrough, where the quantity of the second plurality of holes (14) equals the quantity of the first plurality of holes (6) in the central disk (2). A spoke adjuster (16) is inserted through each of the second plurality of holes (14). The spoke adjuster (16) is mushroom shaped, having a button head and a shaped tubular section, where the shape may be hexagonal or square depending on the manufacturer and which is common in the wire wheel industry. The spoke adjuster (16) has an internally threaded hole defined therethrough, which is also common within the industry.

The wire spokes (8) have a 90 degree bend at a first end (18) and a formed button shape (20) to allow the wire spokes (8) to fix the central disk (2) at a geometric center of the wheel rim (4). The wire spokes (8) have a second end (22) the second end having an externally threaded portion (24). The externally threaded portion (24) of each wire spoke (8) threadably engages each spoke adjuster (16) tensioning each wire spoke (8) thereby. Each spoke adjuster (16) is adjusted to provide the correct tension on each wire spoke (8) making a balanced wheel assembly (1).

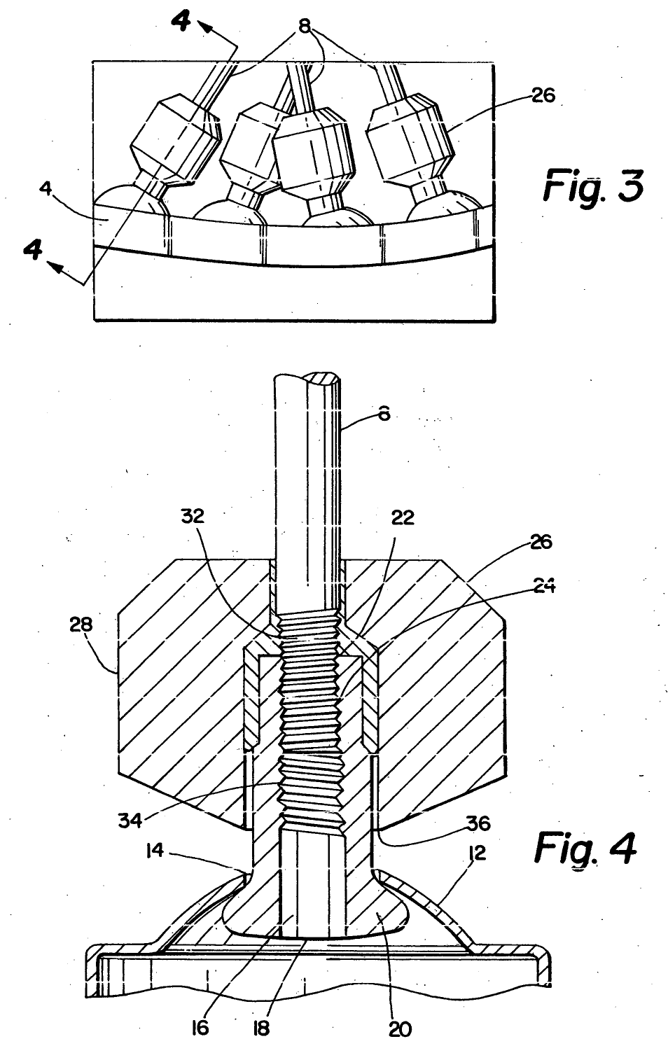

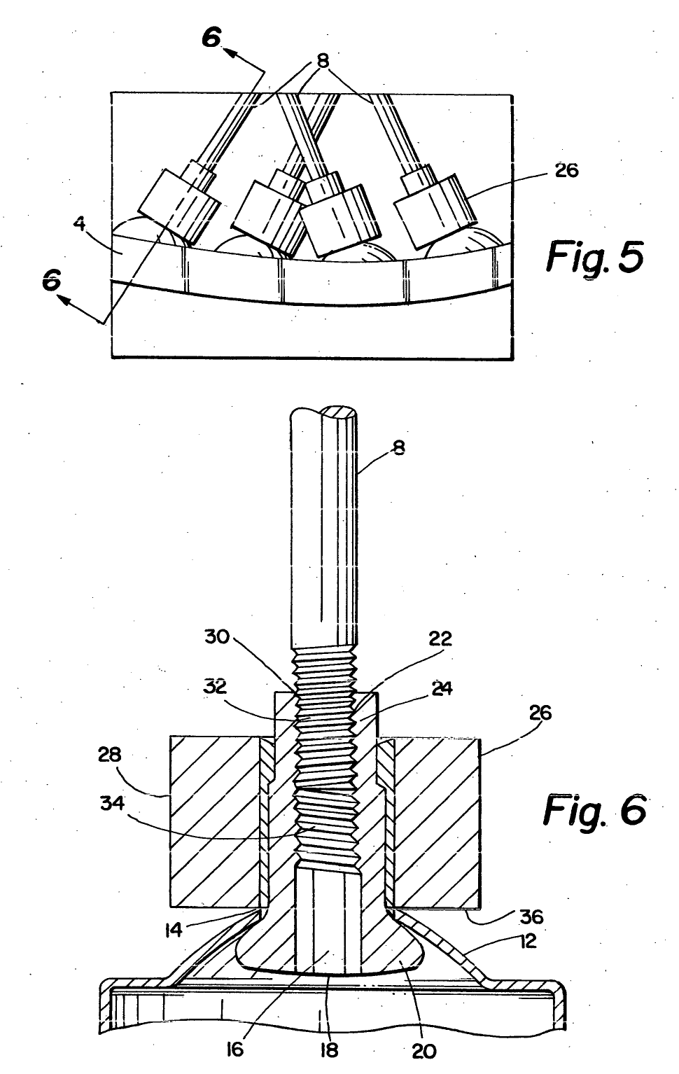

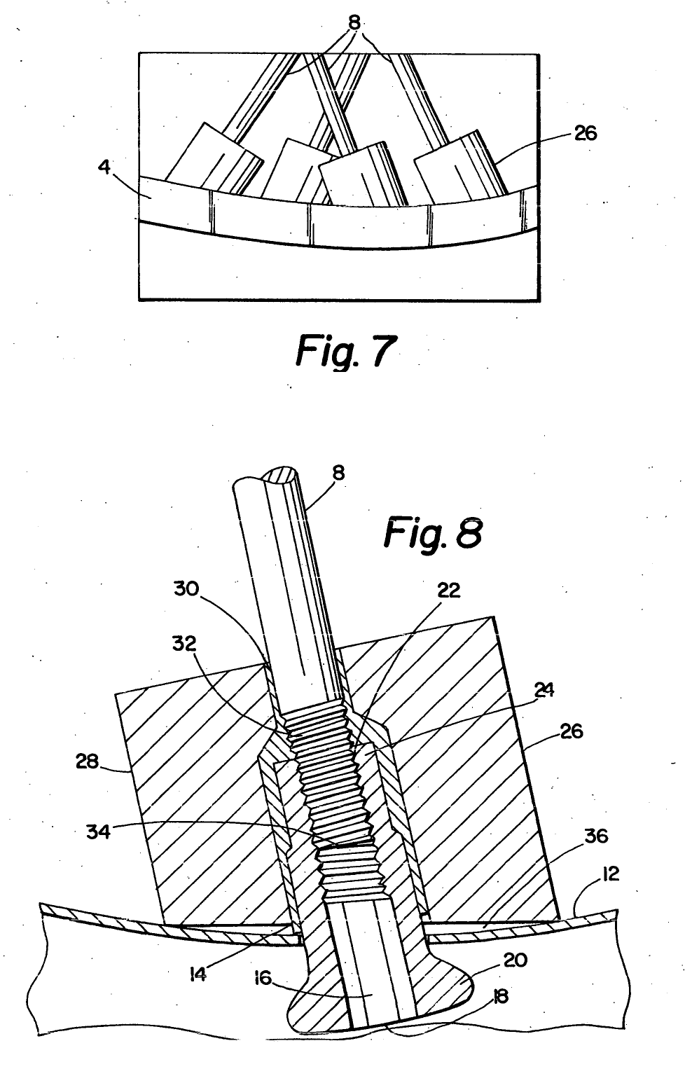

A Spoke Seal Protector (26) is shown in FIG. 3. The Spoke Seal Protector (26) is shown having an exterior surface (28) that is shown as a surface of revolution, and having a centerline, but may be of any shape. The Spoke Seal Protector (26) is shown with a hole (30) defined therethrough. The hole (30) in the spoke seal protector (26) may be centrally located. The hole (30) is linear. The hole (30) has an upper portion (32) where the upper portion (32) allows the wire spoke (8) to be easily inserted therethrough. The hole (30) additionally has a lower counterbored portion (34), where the lower counterbored portion (34) is positioned at an opposing end (36) of the upper portion (32) defining a cavity. The lower counterbored portion or cavity (34) is sized to allow a clearance fit to the spoke adjuster (16) allowing volume therebetween for a sealant. FIGS. 7 and 8 reveal that the spoke seal protector (26) will have an opposed end (36) that has been trimmed or machined at an angle to allow the spoke seal protector (26) to fit closely with the wheel rim (4).

The Spoke Seal Protector (26) is positioned onto the wire spoke (8). The spoke adjuster (16) is inserted through the second plurality of holes (14) and threadably engages the wire spoke (8). The Spoke Seal Protector (26) is slid towards the spoke adjuster (16). The Spoke Seal Protector (26) has a lower surface (36), where the lower surface (36) contacts the bearing surface (12) or the wheel rim (4). Sealants based upon silicone, polysulfide, and rubber are a few examples of high performance automotive or industrial sealants that may be used as a glue, to prevent unwanted dislocation of the Spoke Seal Protector (26) when it is placed in it's final position. The sealant fills the cavity between the Spoke Seal Protector and the wire spoke (8) and the spoke adjuster (16) and provides a strong environmental seal between the spoke seal protector (26) and the wheel rim (4).

Although the drawings reveal geometric shapes, the inventor also envisions other shapes, such as toy cars, Disney® figurines, animal shapes or other similar shapes as alternate shapes that may be used for spoke seal protectors (26). These shapes would have a hole defined therethrough to assure that the surface mating with the wheel rim (4) has a fit that is as intimate as possible.

What is claimed is:

1. A spoke seal protector, comprising:
a) an exterior surface, said exterior surface having a top and a bottom defined thereon, said top of said exterior surface having a hole defined therethrough, said hole being linear and exiting through said bottom of said exterior surface; and
b) said hole additionally having a lower counterbored portion, said lower counterbored portion penetrating said bottom of said exterior surface, said lower counterbored portion being positioned in proximity of said bottom of said exterior surface, said lower counterbored portion being adapted to allow a clearance fit to a spoke adjuster.

2. The spoke seal protector of claim 1, wherein, a common automotive or industrial sealant is placed within said lower counterbored portion and is used to adhere said spoke seal protector to the spoke adjuster and creates an environmental seal thereby.

3. The spoke seal protector of claim 1, wherein;
said spoke seal protector has a lower surface, said lower surface is shaped to intimately contact a bearing surface on a tire rim.

4. The spoke seal protector of claim 1, wherein;
said lower surface of said spoke seal protector is trimmed at an angle to a centerline of the spoke seal protector allowing said spoke to be at an angle to the wire rim.
